(19) United States
(12) Patent Application Publication
(10) Pub. No.: US 2012/0221742 A1
(43) Pub. Date: Aug. 30, 2012

(54) SWITCH CAPABLE OF SAVING POWER AND METHOD THEREOF

(75) Inventor: CHUAN-CHENG HSU, Tu-Cheng (TW)

(73) Assignee: HON HAI PRECISION INDUSTRY CO., LTD., Tu-Cheng (TW)

(21) Appl. No.: 13/159,427

(22) Filed: Jun. 14, 2011

(30) Foreign Application Priority Data
Feb. 28, 2011 (CN) 201110047562.8

(51) Int. Cl. G06F 15/16

(52) U.S. Cl. 709/233

(57) ABSTRACT

A switch capable of saving power is provided. The switch includes at least one transmission port, and each port capable of being connected to one type of network device. The switch detects whether data transmission exists between one port and a network device connected to the port, detects an actual data transmission speed, obtains a discovery protocol, determines the type of the device according to identity information in the discovery protocol, decreases the preset transmission speed to a value which is equal to or exceeds a total of the actual transmission speed and a preset value, upon a condition that difference between the preset transmission speed and the actual data transmission speed is equal to or exceeds a fixed value, and sets the decreased transmission speed to an initial preset transmission speed when the data transmission ends. A corresponding power saving method is also provided.

### BACKGROUND

1. Technical Field

The present disclosure relates to switches and, more particularly, to a switch capable of saving power and a power saving method.

2. Description of Related Art

Network devices such as switches or routers are widely used in data exchange through a network such as the Internet. Each transmission port of each network device has a preset transmission speed. The preset transmission speed of each transmission sport relates to power consumption of the network device. The higher the preset transmission speed is, the more power the network device consumes. If the preset transmission speed is much higher than the actual transmission speed of the port, the network device may consume a lot of unnecessary power, which is wasteful.

It is desirable to provide a switch capable of saving power and a method thereof to solve the problems mentioned above.

### BRIEF DESCRIPTION OF THE DRAWINGS

FIG. 1 is a schematic view showing a switch capable of saving power in accordance with an exemplary embodiment.

FIG. 2 is a flowchart of a power saving method of a switch in accordance with an exemplary embodiment.

### DETAILED DESCRIPTION

The disclosure is illustrated by way of example and not by way of limitation. It should be noted that references to “an” or “one” embodiment in this disclosure are not necessarily to the same embodiment, and such references mean at least one.

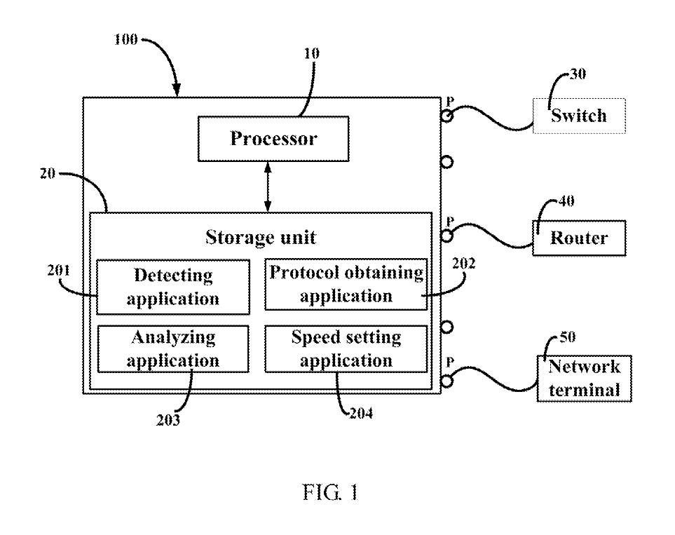

Referring to FIG. 1, a switch 100 capable of saving power includes a processor 10, a storage unit 20, and at least one transmission port P. Each port P can be connected to a type of network device, for example, another switch 30, a router 40, or a network terminal 50. Each type of the network device corresponds to a data transmission speed range. Each port P corresponds to a preset transmission speed V1. The processor 10 dynamically adjusts the preset transmission speed V1 of one transmission port P according to the actual transmission speed V2 of the port P if data transmission exists between the port P and the network device connected to the port P, and sets the adjusted preset transmission speed V1 of the port P to an initial preset transmission speed when data transmission ends. Wherein, the initial preset transmission speed is an appropriate speed for the port P to be suitable for receiving any one type of the different types of network devices, for example, it may be the maximum speed the port P may reach. With such configuration, the processor 10 can dynamically adjust the preset transmission speed V1 according to the speed V2, thus power may be saved during data transmission if the speed V2 is greater less than the speed V1.

The storage unit 20 stores a detecting application 201, a protocol obtaining application 202, an analyzing application 203, and a speed setting application 204. The storage unit 20 further stores a plurality of transmission speed ranges corresponding to the plurality of types of network devices. The processor 10 executes/runs various software components in the storage unit 20 to perform various functions of the switch 100.

The detecting application 201 includes various software components, which may be implemented by the processor 20, to detect in real time whether data transmission exists between one transmission port P of the switch 100 and a network device connected to the transmission port P. As well as detecting the actual data transmission speed V2 of the port P if data transmission exists. In this embodiment, in order to make the adjusting process more stable, the value of the detected actual transmission speed V2 is an average speed determined within a preset period. The protocol obtaining application 202 includes various software components, which may be implemented by the processor 20 to obtain a discovery protocol, which is used in the data transmission and includes identity information of the network device connected to the port P. The analyzing application 203 includes various software components, which may be implemented by the processor 20 to determine the type of the network device according to the identity information in the obtained discovery protocol, for example, to determine whether the network device connected to the port P is the switch 30, the router 40, or the network terminal 50.

The speed setting application 204 includes various software components, which may be implemented by the processor 20, to determine whether a difference between the speed V1 and the speed V2 is equal to or greater than a fixed value, such as 10 Mb/s, and decrease the preset transmission speed V1 of the port P to a proper value which is equal to a total of the detected actual transmission speed V2 and a preset value such as 5 Mb/s, when the difference is equal to or exceeds the fixed value, wherein the total is within one of the plurality of data transmission speed ranges corresponding to the type of the network device. The speed setting application 204 is further implemented by the processor 20 to set the decreased preset speed V1 to the initial preset speed when the data transmission ends. In this embodiment, the data transmission speed range Vc corresponding to the switch 30 is greater than the data transmission speed range Vb corresponding to the router 40, and the data transmission speed range Vb corresponding to the router 40 is greater than the data transmission speed range Va corresponding to the network terminal 50. For example, the range Va may be 1 Mb/s-100 Mb/s, the range Vb may be 101 Mb/s-500 Mb/s, and the range Vc may be 501 Mb/s-1000 Mb/s.

When the port P is connected to a network terminal 50, the preset transmission speed V1 of the port P may be set by the speed setting application 204 to a proper value, which is equal to a total of the detected actual transmission speed V2 of the port P and a preset value and is within the range Va. For example, when the detecting application 201 detects that the actual transmission speed V2 between the port P and the terminal 50 is 30 Mb/s, and the initial preset transmission speed V1 is 1000 Mb/s, wherein the (V1−V2) is 970 Mb/s, which is greater than 10 Mb/s, and the speed setting application 204 decreases the speed V1 to 35 Mb/s, which is in the range Va if the preset value is 5 Mb/s.

When the port P is connected to a router 40, the preset transmission speed V1 of the port P may be set by the speed setting application 204 to a proper value which is equal to a total of the detected actual transmission speed V2 of the port P and a preset value and is within the range Vb. For example, when the detecting application 201 detects that the actual transmission speed V2 between the port P and the router 40 is 400 Mb/s, and the initial preset transmission speed V1 of the port P is 1000 Mb/s, wherein the (V1−V2) is 600 Mb/s, which is greater than 10 Mb/s, the speed setting application 204 may set the speed V1 to 405 Mb/s, which is in the range Vb if the preset value is 5.

When the port P is connected to a switch 30, the preset transmission speed V1 of the port P may be set by the speed setting application 204 to a proper value which is equal to a total of the detected actual transmission speed V2 of the port P and the preset value and is within the range Vc. For example, when the detecting application 201 detects that the actual transmission speed V2 between the port P and the switch 30 is 996 Mb/s, and the initial preset transmission speed V1 of the port P is 1000 Mb/s, wherein the (V1−V2) is 4 Mb/s, which is less than 10 Mb/s, the speed setting application 204 may not adjust the speed V1.

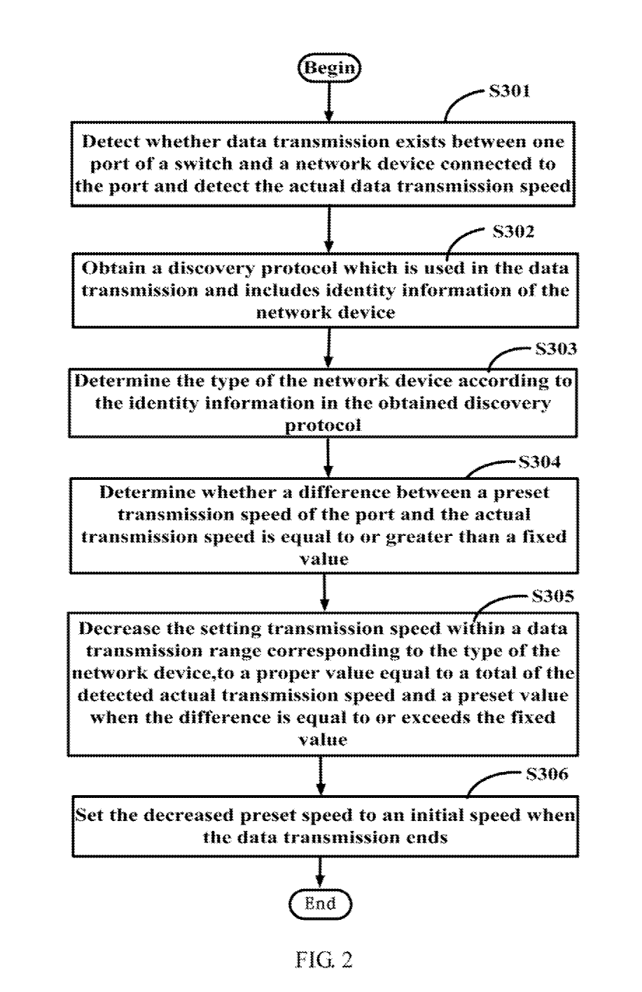

Referring to FIG. 2, a flowchart of a power saving method of the switch 100 in accordance with an exemplary embodiment is illustrated.

In step S301, the detecting application 201 is implemented by the processor 102 to detect whether data transmission exists between one port P of the switch 100 and a network device connected to the port P, and detect the actual data transmission speed V2 between the port P and the network device when data transmission exists.

In step S302, the protocol obtaining application 202 is implemented by the processor 102 to obtain a discovery protocol, which is used in the data transmission and includes identity information of the network device.

In step S303, the analyzing application 203 is implemented by the processor 102 to determine the type of the network device according to the identity information in the obtained discovery protocol.

In step 304, the speed setting application 204 is implemented by the processor 102 to determine whether a difference between the speed V1 and the speed V2 is equal to or greater than a fixed value.

In step 305, the speed setting application 204 is further implemented by the processor 102 to decrease the preset transmission speed V1 of the port P to a proper value, which is equal to a total of the detected actual transmission speed V2 and a preset value when the difference is equal to or exceeds the fixed value, wherein, the total is within the data transmission speed range corresponding to the type of the network device.

In step 306, the speed setting application 204 is further implemented by the processor 20 to set the decreased preset speed V1 to the initial speed when the data transmission ends.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A switch capable of saving power, comprising:
a storage unit storing a plurality of applications and a plurality of data transmission speed ranges corresponding to a plurality of types of network devices;
at least one transmission port each capable of being connected to one type of the plurality of types of network devices; and
a processor to execute the plurality of applications,
wherein the plurality of applications comprises instructions executable by the processor to:
detect whether data transmission exists between one of the at least one transmission port and a network device connected to the one transmission port, and detect an actual data transmission speed between the one port and the network device if data transmission exists;
obtain a discovery protocol comprising identity information of the network device;
determine the type of the network device according to the identity information in the obtained discovery protocol;
decrease a preset transmission speed of the one port to a value which is equal to a total of the detected actual transmission speed and a preset value and is within one of the plurality of data transmission speed ranges corresponding to the type of the network device upon a condition that the difference between the preset transmission speed and the actual data transmission speed is equal to or exceeds a fixed value; and
set the decreased preset transmission speed of the one port to an initial preset transmission speed when the data transmission between the one port and the network device ends.

2. The switch as described in claim 1, wherein the initial preset transmission speed is an appropriate speed for the one port to connect any one type of the different types of network devices.

3. The switch as described in claim 2, wherein the initial preset transmission speed is a maximum speed the one port can reach.

4. The switch as described in claim 1, wherein the actual transmission speed is an average speed determined within a preset period.

5. The switch as described in claim 1, wherein the different data transmission speed ranges comprises a first data transmission speed range corresponding to a network terminal, a second data transmission speed range corresponding to a router, and a third data transmission speed range corresponding to a switch.

6. The switch as described in claim 5, wherein the first data transmission speed range is less than the second data transmission speed range and the third data transmission speed range, and the second data transmission speed range is less than the third data transmission speed range.

7. A method for saving power of a switch, the switch comprising a storage unit and at least one transmission sport, the storage unit storing a plurality of data transmission speed ranges corresponding to a plurality of types of network devices, each of the at least one transmission port capable of being connect to one type of the plurality of types of network devices, the method comprising:
detecting whether data transmission exists between one of the at least one transmission port and a network device connected to the one transmission port, and detecting the actual data transmission speed between the one transmission port and the network device if data transmission exists;
obtaining a discovery protocol comprising identity information of the network device;
determining the type of the network device according to the identity information in the obtained discovery protocol;
determining whether the difference between a preset transmission speed of the one transmission port and the actual data transmission speed is equal to or exceeds a fixed value;
decreasing the preset transmission speed of the one port to a value which is equal to a total of the detected actual transmission speed and a preset value and is within one of the plurality of data transmission speed ranges corresponding to the type of the network device, upon a condition that the difference is equal to or exceeds the fixed value; and
setting the decreased preset transmission speed of the one port to an initial preset transmission speed when the data transmission between the one port and the network device ends.

8. The method as described in claim 7, wherein the initial preset transmission speed is an appropriate speed for the one port to connect any one type of the different types of network devices.

9. The method as described in claim 8, wherein the initial preset transmission speed is a maximum speed the one port can reach.

10. The method as described in claim 7, wherein the actual transmission speed is an average speed determined within a preset period.

11. The method as described in claim 7, wherein the different data transmission speed ranges comprises a first data transmission speed range corresponding to a network terminal, a second data transmission speed range corresponding to a router, and a third data transmission speed range corresponding to a switch, the first data transmission speed range is less than the second data transmission speed range and the third data transmission speed range, and the second data transmission speed range is less than the third data transmission speed range.
